(19) United States
(12) Patent Application Publication
(10) Pub. No.: US 2019/0347216 A1
(43) Pub. Date: Nov. 14, 2019

(54) METHOD FOR CONNECTING EXTERNAL DEVICE AND ELECTRONIC DEVICE SUPPORTING SAME

(71) Applicant: Samsung Electronics Co., Ltd., Gyeonggi-do (KR)

(72) Inventors: Ka Won CHEON, Seoul (KR); Do Hyoung KIM, Seoul (KR); Seong Hoon KANG, Gyeonggi-do (KR); Min Kyu JUNG, Seoul (KR)

(21) Appl. No.: 16/474,824

(22) PCT Filed: Dec. 28, 2017
(86) PCT No.: PCT/KR2017/015660

§ 371 Date: Jun. 28, 2019

(30) Foreign Application Priority Data
Dec. 28, 2016 (KR) 10-2016-0181475

(51) Int. Cl. G06F 13/10; H04L 29/08; G06F 3/14; H04L 29/06

(52) U.S. Cl. CPC G06F 13/102; H04L 67/306; G06F 3/14; H04W 4/80; H04L 67/141; H04L 63/08; H04L 67/16

(57) ABSTRACT

An electronic device may be connected to an external device via a network. The electronic device may include a display, a communication interface, a memory, and a processor. The processor may recognize peripheral devices via the wired or wireless communication, receive connection information for connection to the external device from at least one of the peripheral devices, remotely control the external device or output the content stored in the external device on the display, based on the received connection information. In addition, various embodiments are possible which are understood through the specification.

### TECHNICAL FIELD

Various embodiments of the disclosure are related to a method for transmitting and receiving data in connection with an external electronic device and an electronic device supporting the same.

### BACKGROUND ART

An electronic device such as a desktop PC, a laptop PC, and the like may output various content (e.g., texts, images, or the like) on a display. The electronic device may display an execution screen of a program or an application executed by an internal processor and a memory on the display.

The electronic device (hereinafter, referred to as a first electronic device) may remotely control another electronic device (hereinafter, referred to as a second electronic device) connected thereto via a network to output a screen executed in the second electronic device. A user input or the like performed in the first electronic device may be transmitted to the second electronic device and executed in the second electronic device.

The first electronic device may access data (e.g., media files, image files, document files, or the like) stored in a specific area of a memory within the second electronic device. The first electronic device may execute or use a file stored within the second electronic device.

When the first electronic device transmits files such as photos, videos, or the like to a peripheral external device, the first electronic device may transmit the files via a remote communication scheme (e.g., Internet, cellular communication using a base station) or a short-range communication (e.g., Wi-Fi direct, Bluetooth, or the like).

### DISCLOSURE

### Technical Problem

When a conventional electronic device outputs content received from an external device, the conventional electronic device may passively approve upon a request from the external device to mirror or output a screen.

In addition, when a screen of a device such as an external desktop PC or the like is remotely shared and displayed, an access authentication process is complicated. Further, when an approval is not completed in a source device, remote control may not be performed.

### Technical Solution

An electronic device according to various embodiments of the disclosure may be connected to an external device via a network. The electronic device may include a display that may output internal content of the electronic device or content received from the external device, a communication interface that may support a wired or wireless communication, a memory, and a processor. The processor may recognize peripheral devices via the wired or wireless communication, receive connection information for connection to the external device from at least one of the peripheral devices, remotely control the external device or output content stored in the external device on the display, based on the received connection information.

### Advantageous Effects

A method for connecting a device and an electronic device supporting the same according to various embodiments of the present disclosure may obtain connection information for connection to a source device via a user's personal terminal such as a smart phone or the like and share and output a screen of the source device based on the corresponding connection information.

The method for connecting the device and the electronic device supporting the same according to various embodiments of the present disclosure may perform an authentication process via the smart phone of the user and output the screen of the source device when the authentication is completed. The user may easily access the source device even when the user is outside.

### DESCRIPTION OF DRAWINGS

FIG. 1 illustrates an electronic device in a network environment.

FIG. 2 illustrates a connection between devices using an authentication device according to various embodiments.

FIGS. 3a to 3c are exemplary diagrams using networks according to various embodiments.

FIG. 4 is a flowchart illustrating a process of exporting connection information according to various embodiments.

FIG. 5 is an exemplary diagram of a screen illustrating a process of exporting connection information according to various embodiments.

FIG. 6a is an exemplary diagram of a screen illustrating a process of exporting connection information for a file according to various embodiments.

FIG. 6b is an exemplary diagram of composition of connection information according to various embodiments.

FIG. 7 is a flowchart illustrating a process of accessing an external device using connection information according to various embodiments.

FIG. 8 is an exemplary diagram of remote control according to various embodiments.

FIG. 9 is an exemplary diagram of connection failure screen according to various embodiments.

FIG. 10 illustrates a block diagram of an electronic device according to various embodiments.

FIG. 11 illustrates a block diagram of a program module according to various embodiments.

### MODE FOR INVENTION

Hereinafter, various embodiments of the present disclosure will be described with reference to the accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the disclosure disclosed herein, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. CPU, for example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. According to various embodiments of the present disclosure, the wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital video disk (DVD) player, an audio, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller's machine (ATM) of a financial company, a point of sales (POS) of a store, or an internet of things (for example, a bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). In various embodiments of the present disclosure, the electronic device may be one or a combination of the aforementioned devices. The electronic device according to some embodiments of the present disclosure may be a flexible electronic device. Further, the electronic device according to an embodiment of the present disclosure is not limited to the aforementioned devices, but may include new electronic devices produced due to the development of technologies.

Hereinafter, electronic devices according to an embodiment of the present disclosure will be described with reference to the accompanying drawings. The term “user” used herein may refer to a person who uses an electronic device or may refer to a device (for example, an artificial electronic device) that uses an electronic device.

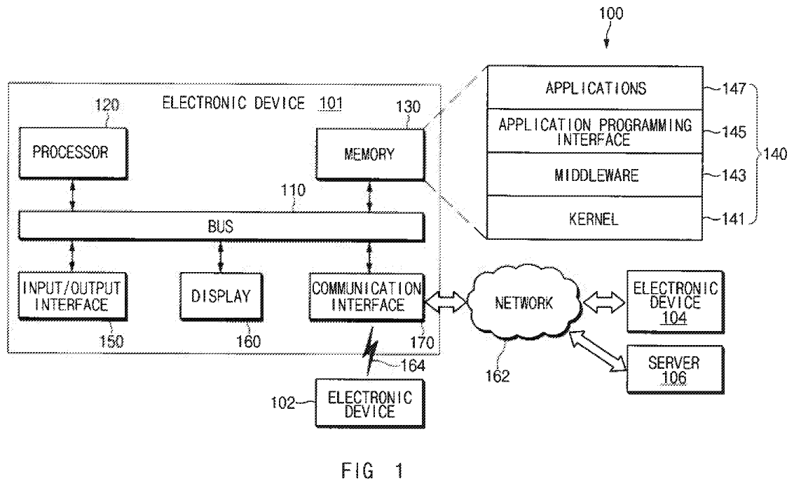

An electronic device 101 in a network environment 100 according to various embodiments of the present disclosure will be described with reference to FIG. 1. The electronic device 101 may include a bus 110, a processor 120, a memory 130, an input/output interface 150, a display 160, and a communication interface 170. In various embodiments of the present disclosure, at least one of the foregoing elements may be omitted or another element may be added to the electronic device 101.

The bus 110 may include a circuit for connecting the above-mentioned elements 110 to 170 to each other and transferring communications (e.g., control messages and/or data) among the above-mentioned elements.

The processor 120 may include at least one of a central processing unit (CPU), an application processor (AP), or a communication processor (CP). The processor 120 may perform data processing or an operation related to communication and/or control of at least one of the other elements of the electronic device 101.

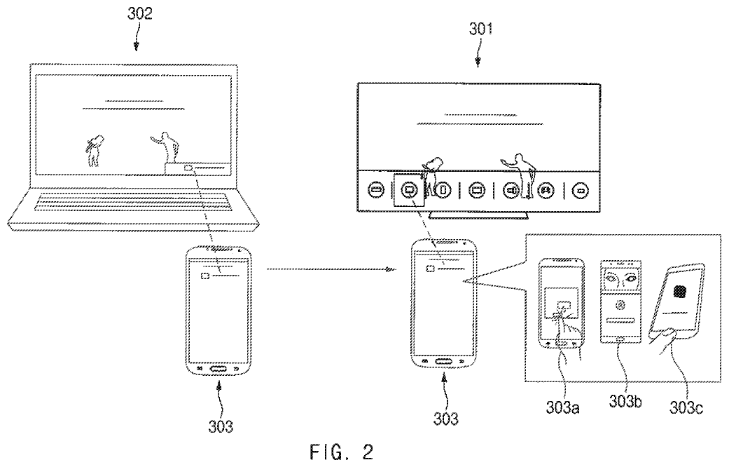

According to various embodiments, the processor 120 may recognize a peripheral electronic device (e.g., electronic device 102) or an electronic device (e.g., electronic device 104) connected via network 162, using the communication interface 170. Processor 120 may request remote control from a recognized external device (e.g., electronic device 102, 104). Or, the processor 120 may request to provide data stored in the recognized external device (e.g., electronic device 102, 104). Additional relevant information may be provided through FIGS. 2a and 2b.

According to various embodiments, the processor 120 may recognize the recognized external device (e.g., electronic device 102, 104) based on connection information previously stored in memory 130, without authentication or with user authentication process performed in the electronic device 101.

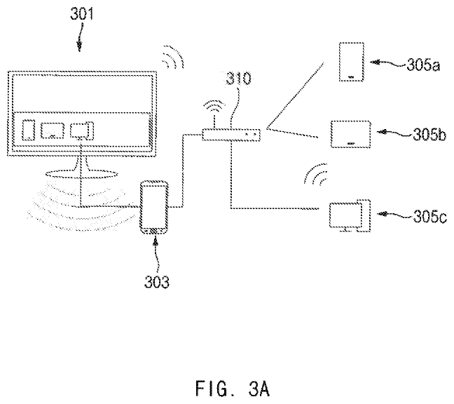

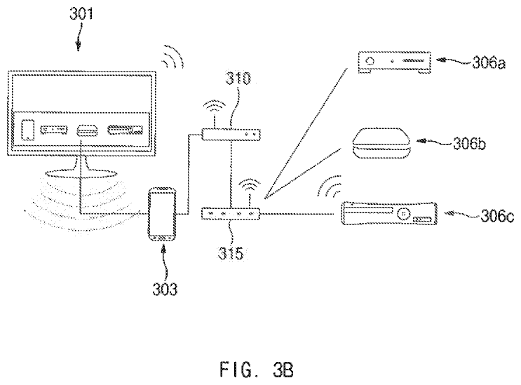

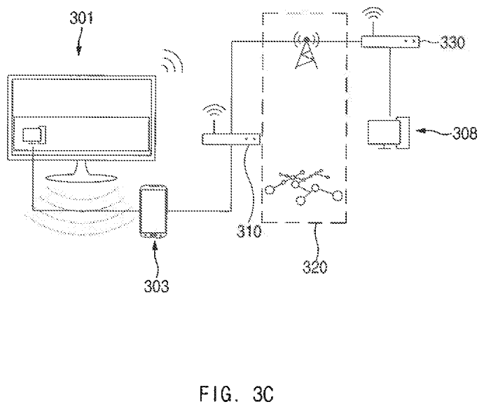

According to various embodiments, the processor 120 may recognize a peripheral device (e.g., electronic device 102) by wired communication or wireless communication within a specified distance. The processor 120 may request connection information to access another external device (e.g., electronic device 104) stored in a recognized peripheral device (e.g., electronic device 102). Additional information related to this can be provided through FIGS. 3a and 3b.

The memory 130 may include a volatile memory and/or a nonvolatile memory. The memory 130 may store instructions or data related to at least one of the other elements of the electronic device 101. According to an embodiment of the present disclosure, the memory 130 may store software and/or a program 140. The program 140 may include, for example, a kernel 141, a middleware 143, an application programming interface (API) 145, and/or an application program (or an application) 147. At least a portion of the kernel 141, the middleware 143, or the API 145 may be referred to as an operating system (OS). The kernel 141 may control or manage system resources (e.g., the bus 110, the processor 120, the memory 130, or the like) used to perform operations or functions of other programs (e.g., the middleware 143, the API 145, or the application program 147). Furthermore, the kernel 141 may provide an interface for allowing the middleware 143, the API 145, or the application program 147 to access individual elements of the electronic device 101 in order to control or manage the system resources.

The middleware 143 may serve as an intermediary so that the API 145 or the application program 147 communicates and exchanges data with the kernel 141. Furthermore, the middleware 143 may handle one or more task requests received from the application program 147 according to a priority order. For example, the middleware 143 may assign at least one application program 147 a priority for using the system resources (e.g., the bus 110, the processor 120, the memory 130, or the like) of the electronic device 101. For example, the middleware 143 may handle the one or more task requests according to the priority assigned to the at least one application, thereby performing scheduling or load balancing with respect to the one or more task requests. The API 145, which is an interface for allowing the application 147 to control a function provided by the kernel 141 or the middleware 143, may include, for example, at least one interface or function (e.g., instructions) for file control, window control, image processing, character control, or the like. The input/output interface 150 may serve to transfer an instruction or data input from a user or another external device to (an)other element(s) of the electronic device 101. Furthermore, the input/output interface 150 may output instructions or data received from (an)other element(s) of the electronic device 101 to the user or another external device.

The display 160 may include, for example, a liquid crystal display (LCD), a light-emitting diode (LED) display, an organic light-emitting diode (OLED) display, a microelectromechanical systems (MEMS) display, or an electronic paper display. The display 160 may present various content (e.g., a text, an image, a video, an icon, a symbol, or the like) to the user. The display 160 may include a touch screen, and may receive a touch, gesture, proximity or hovering input from an electronic pen or a part of a body of the user.

The communication interface 170 may set communications between the electronic device 101 and an external device (e.g., a first external electronic device 102, a second external electronic device 104, or a server 106). For example, the communication interface 170 may be connected to a network 162 via wireless communications or wired communications so as to communicate with the external device (e.g., the second external electronic device 104 or the server 106).

A wireless communication using the network 162 (hereinafter referred to as a first communication method) may be performed by using a mobile communication system such as LTE, LTE-A (LTE Advance), CDMA (code division multiple access), WCDMA (wideband CDMA), UMTS (universal mobile telecommunications system), WiBro (Wireless Broadband), or GSM (Global System for Mobile Communications), or the like.

According to one embodiment, the wireless communication may comprise a GNSS. GNSS may be, for example, GPS (Global Positioning System), Glonass (Global Navigation Satellite System), Beidou Navigation Satellite System (hereinafter “Beidou”) or Galileo, the European global satellite-based navigation system. Hereinafter, in this document, “GPS” can be used interchangeably with “GNSS”.

Wireless communication using a local area network (hereinafter, referred to as a second communication method) includes at least one of WiFi (wireless fidelity), Bluetooth, Bluetooth low power (BLE), wi-di, Zigbee, NFC (near field communication), magnetic secure transmission, radio frequency (RF), or body area network (BAN).

The wired communications may include at least one of universal serial bus (USB), high definition multimedia interface (HDMI), recommended standard 832 (RS-232), plain old telephone service (POTS), or the like.

The types of the first external electronic device 102 and the second external electronic device 104 may be the same as or different from the type of the electronic device 101. According to an embodiment of the present disclosure, the server 106 may include a group of one or more servers. A portion or all of operations performed in the electronic device 101 may be performed in one or more other electronic devices (e.g., the first electronic device 102, the second external electronic device 104, or the server 106). When the electronic device 101 should perform a certain function or service automatically or in response to a request, the electronic device 101 may request at least a portion of functions related to the function or service from another device (e.g., the first electronic device 102, the second external electronic device 104, or the server 106) instead of or in addition to performing the function or service for itself. The other electronic device (e.g., the first electronic device 102, the second external electronic device 104, or the server 106) may perform the requested function or additional function, and may transfer a result of the performance to the electronic device 101. The electronic device 101 may use a received result itself or additionally process the received result to provide the requested function or service. To this end, for example, a cloud computing technology, a distributed computing technology, or a client-server computing technology may be used.

FIG. 2 is a configuration diagram illustrating a connection between devices using an authentication device according to various embodiments.

Referring to FIG. 2, a first electronic device 301 may request provision of content to a second electronic device 302 using information stored in an authentication device 303. For example, the first electronic device 301 and the second electronic device 302 may be in a state of being connected with each other via a wired/wireless communication network (e.g., Internet and cellular communication) rather than a short-range wireless communication (e.g., Bluetooth, Bluetooth Low Energy (BLE), Wi-Fi direct (Wi-Di), or the like). On the other hand, the first electronic device 301 may be connected to the authentication device 303 via the short-range wireless communication (e.g., Bluetooth, Bluetooth Low Energy (BLE), Wi-Fi direct (Wi-Di), or the like).

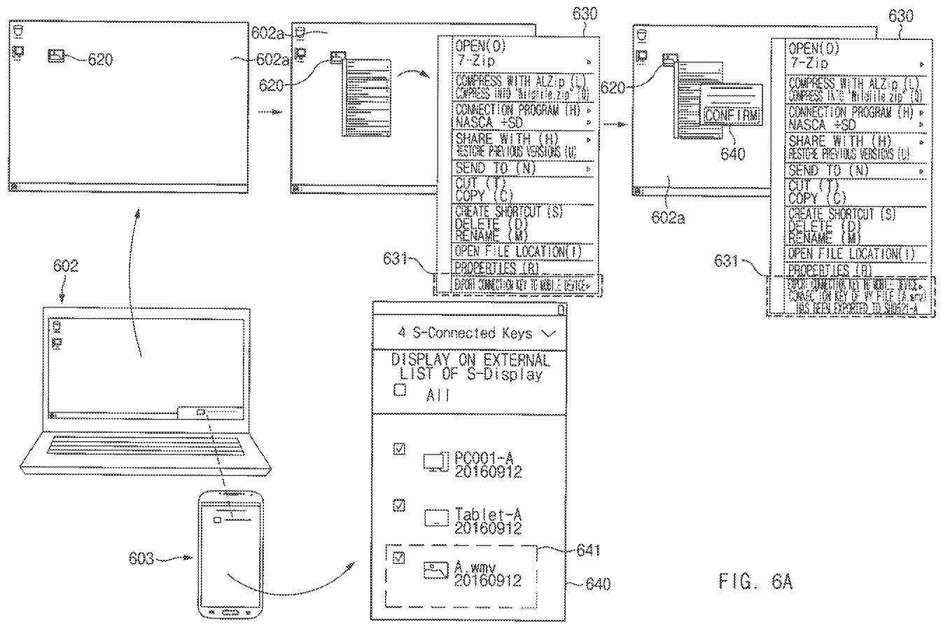

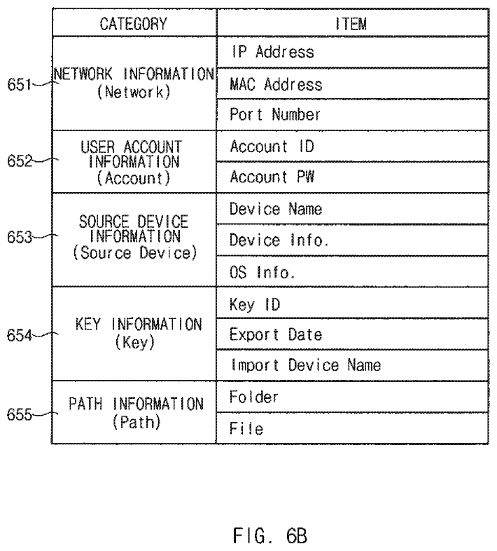

The second electronic device 302 may transmit, to the authentication device 303, connection information (or a connection key) for accessing the content stored therein in advance (before the first electronic device 301 and the authentication device 303 are connected with each other via the short-range communication). The connection information may include information such as network information (e.g., IP address, MAC address, and the like), user account information (e.g., user ID/password), and the like for accessing the second electronic device 302. Additional information on composition of the connection information may be provided in FIG. 6b.

The authentication device 303 may store the received connection information in an internal memory. In various embodiments, when the authentication device 303 receives connection information respectively from a plurality of external devices, the authentication device 303 may list and manage the connection information. For example, the authentication device 303 may store connection information for each of a desktop PC, a laptop PC, a tablet PC, and the like used by the same user. The user may store connection information of a frequently used electronic device in the authentication device 303 (e.g., a smart phone) and access the electronic device from an outside as needed.

The authentication device 303 may be connected to the first electronic device 301 via the wired/wireless communication while being in a state in which the connection information of the second electronic device 302 is stored. For example, the authentication device 303 may be in a state of being associated with the first electronic device 301 such that the short-range wireless communication such as Bluetooth, Wi-Fi direct, or the like is allowed therebetween. In one embodiment, the authentication device 303 may transmit a response signal in response to a device search message transmitted from the first electronic device 301. Thus, the authentication device 303 may enter an associated mode with the first electronic device 301 to allow the short-range communication therebetween.

The first electronic device 301 may display, on a screen, a list of the second electronic devices 302 that are connectable via the authentication device 303. When an input from the user of selecting one in the list occurs, the first electronic device 301 may request the authentication device 303 to transmit the connection information.

When the transmission of the connection information is requested from the first electronic device 301, the authentication device 303 may perform an authentication process for the user. For example, the authentication process may be a preset scheme such as a touch input 303a, an iris recognition 303b, a fingerprint recognition 303c, and the like.

When the user authentication process is completed, the authentication device 303 may transmit the connection information to the first electronic device 301. According to one embodiment, the authentication device 303 may transmit some information required for accessing the second electronic device 302 of the information contained in the connection information.

The first electronic device 301 may transmit a signal requesting the content to the second electronic device 302 using the received connection information. For example, in a case of remote control, the first electronic device 301 may transmit, to the second electronic device 302, a request signal containing connection information (e.g., user ID/password) required for remotely controlling the second electronic device 302. The second electronic device 302 may determine a validity of the received connection information. When the received connection information is valid, the second electronic device 302 may establish a protocol for the remote control with the first electronic device 301.

FIGS. 3a to 3c are exemplary diagrams illustrating the connection between devices using networks according to various embodiments.

Referring to FIG. 3a, the first electronic device 301 may be connected to a plurality of second electronic devices 305a to 305c via an internal network device (e.g., wired/wireless router) 310 within the same network environment.

The first electronic device 301 may request provision of content to at least one of the plurality of second electronic devices 305a to 305c using the connection information stored in the authentication device 303.

According to various embodiments, the first electronic device 301 may recognize the plurality of second electronic devices 305a to 305c using the connection information stored in the authentication device 303. Alternatively, the first electronic device 301 may recognize the plurality of second electronic devices 305a to 305c via the network device (e.g., wired/wireless router) 310 without using the authentication device 303.

When one of the second electronic devices 305a to 305c is recognized redundantly, the first electronic device 301 may be configured to preferentially select one recognition scheme of the device as recognized redundantly. For example, when the second electronic device 305c is recognized redundantly, the first electronic device 301 may be configured to preferentially apply a scheme in which the first electronic device 301 accesses the second electronic device 305c using the connection information stored in the authentication device 303.

Referring to FIG. 3b, the first electronic device 301 may be connected to a plurality of second electronic devices 306a to 306c via the internal network device (e.g., wired/wireless router) 310 and a streaming device 315 in the same network environment. The streaming device 315 may be a device for integrally managing the second electronic devices 306a to 306c.

The first electronic device 301 may request provision of content to at least one of the plurality of second electronic devices 306a to 306c using the connection information stored in the authentication device 303.

According to various embodiments, the first electronic device 301 may recognize the plurality of second electronic devices 306a to 306c using the connection information stored in the authentication device 303. Alternatively, the first electronic device 301 may recognize the plurality of second electronic devices 306a to 306c via the network device (e.g., wired/wireless router) 310 and the streaming device 315 without using the authentication device 303. When the second electronic devices 306a to 306c are recognized redundantly, the first electronic device 301 may be configured to preferentially select one recognition scheme. For example, the first electronic device 301 may be configured to preferentially apply a scheme for accessing the redundantly recognized second electronic device 306c using the connection information stored in the authentication device 303.

Referring to FIG. 3c, the first electronic device 301 may be connected to a second electronic device 308 via the internal network device 310 and external network devices 320 and 330. The first electronic device 301 may request provision of content to the second electronic device 308 using the connection information stored in the authentication device 303. The first electronic device 301 may access the second electronic device 308 using the network information (e.g., IP address, MAC address, port information, or the like) contained in the connection information.

The first electronic device 301 may request the provision of the content (e.g., remote control, screen mirroring, file execution, or the like) to the second electronic device 308 using the user account information (e.g., user ID/password) contained in the connection information.

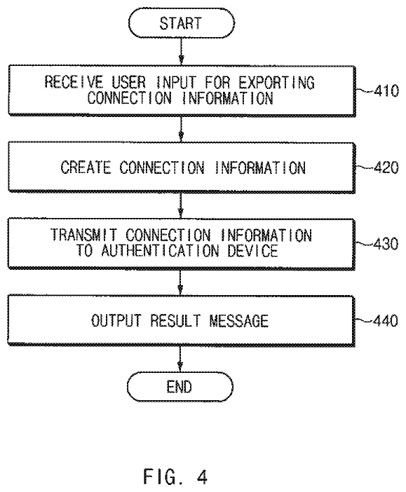

FIG. 4 is a flowchart illustrating a process of exporting connection information according to various embodiments.

Referring to FIG. 4, in operation 410, the second electronic device 302 may receive a user input for exporting the connection information. For example, the user input may be double-clicking of an icon, clicking of a shortcut on a status bar, clicking of left mouse button and then selecting of export, or the like.

In operation 420, the second electronic device 302 may create the connection information. The connection information may include the information such as the network information (e.g., IP address, MAC address, and the like), the user account information (e.g., user ID/password), and the like for accessing the second electronic device 302. In one embodiment, the connection information may additionally include information about an ID, creation date, expiration date, permission authority, and the like for a unique key.

In operation 430, the second electronic device 302 may transmit the created connection information to the authentication device 303. The authentication device 303 may transmit result information about reception and storage of the connection information to the second electronic device 302.

In operation 440, the second electronic device 302 may output a result message based on the transmission result. For example, the second electronic device 302 may output a transmission completion message on a display when the connection information creation and transmission are completed. In another example, the second electronic device 302 may output a transmission failure message to the display when the connection information is not created or the transmission fails.

According to various embodiments, the second electronic device 302 may store a history of execution of the export of the connection information. For example, the second electronic device 302 may sequentially store the history of date and time, transmitted device, expiration date, authority information, and the like of the execution of the export of the connection information. The user may identify the corresponding history and modify the expiration date, the authority information, or the like.

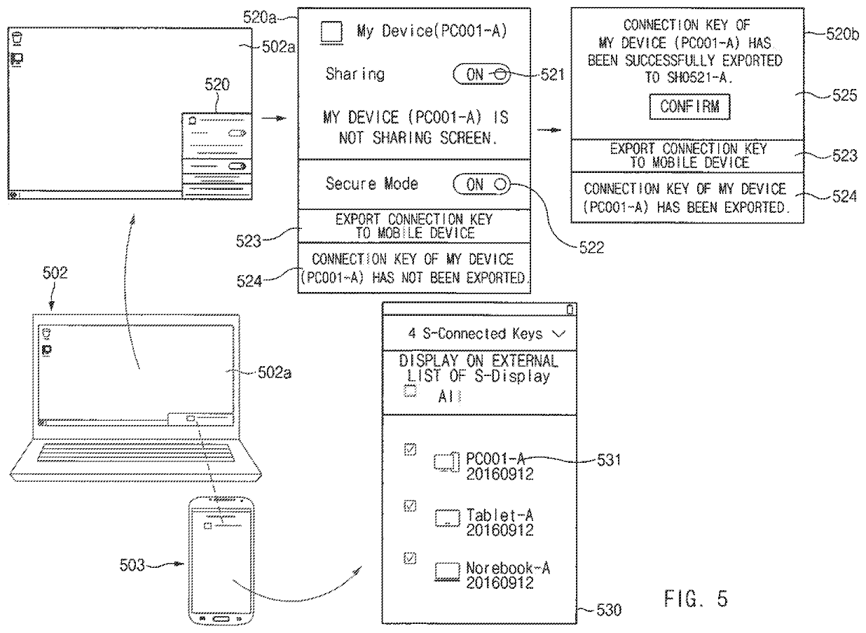

FIG. 5 is an exemplary diagram of a screen illustrating a process of exporting connection information according to various embodiments. FIG. 5 is illustrative, and the disclosure is not limited thereto.

Referring to FIG, 5, a second electronic device 502 may receive a user input for exporting connection information. For example, the user input may be an input of clicking a shortcut in a status bar. The second electronic device 502 may output a UI 520 for exporting the connection information on at least a portion of a display 502a.

According to various embodiments, when an authentication device 503 is recognized or when a specified user input occurs in the authentication device 503, the second electronic device 502 may automatically output the UI 520.

A UI 520a before exporting the connection information may include a content sharing button 521, a secure mode button 522, an export button 523, and a notification region 524.

The content sharing button 521 may be a button for activating or deactivating an entire process of exporting the connection information.

The secure mode button 522 may be a button for determining whether or not to perform setting of a password, setting a user authentication, or the like on the connection information.

The export button 523 may be a button for starting creation and transmission of the connection information.

The notification region 524 may be a region where a result of the exporting of the connection information is output.

After exporting the connection information, a UI 520b may output a transmission result 525. For example, when the creation and the transmission of the connection information is completed, a transmission completion message may be output in the transmission result 525. Conversely, when the connection information is not created or the transmission fails, a transmission failure message may be output in the transmission result 525.

The authentication device 503 may receive the connection information. The authentication device 503 may store the connection information in an internal memory. In one embodiment, the authentication device 503 may receive and store not only the connection information from the second electronic device 502 but also connection information respectively from other devices. The authentication device 503 may list and manage respective connection information.

A connection information list 530 may include an ID of a device transmitted the connection information stored in the authentication device 503 and a device selection button. For example, when the connection information export of the second electronic device 502 is successful, a device icon 531 may be generated together with identification information of the second electronic device 502.

FIG. 6a is an exemplary diagram of a screen illustrating a process of exporting connection information for a file according to various embodiments. FIG. 6a illustrates an exemplary case of transmitting connection information for a media file, but is not limited thereto.

Referring to FIG. 6a, a second electronic device 602 may receive a user input for exporting connection information for a specified content (e.g., a folder and a file). For example, the user input may be an input of selecting an icon of a media file 620 and clicking a left mouse button. The second electronic device 602 may output a UI 630 for exporting the connection information on at least a portion of a display 602a.

When the user selects a connection information export 631 among a plurality of items in the UI 630, the connection information export for the media file 620 may be executed.

In one embodiment, a transmission result may be output as a message in a portion of the connection information export 631. For example, when the connection information creation and transmission is completed, a transmission completion message may be output. Conversely, when the connection information is not created or the transmission fails, a transmission failure message may be output.

An authentication device 603 may receive the connection information for the media file 620. The authentication device 603 may store the connection information for the media file 620 in an internal memory. A connection information list 640 may output an icon and identification information (e.g., file name, file type, or the like) 641 corresponding to the media file 620.

FIG. 6b is an exemplary diagram of composition of connection information according to various embodiments. FIG. 6b is illustrative, and the disclosure is not limited thereto.

Referring to FIG. 6b, connection information may include network information 651, user account information 652, source device information 653, key information 654, path information 655, and the like.

The network information 651 may include information such as an IP address, a MAC address, a port number, and the like of a source device (e.g., the second electronic device 301) that provides content.

The user account information 652 may include an ID, a password, and the like of the user.

The source device information 653 may include a device name, device information (e.g., device type, device configuration, or the like), operating system information, and the like of the source device (e.g., the second electronic device 301) providing the content.

The key information (or security information) 654 may be information for security enhancement, and may include key identification information, export date information, identification information of a received authentication device, and the like.

When accessing a specified content, a storage location of the corresponding content may be recorded in the path information 655. For example, a storage location of a folder, a storage location of a file, and the like may be recorded in the path information.

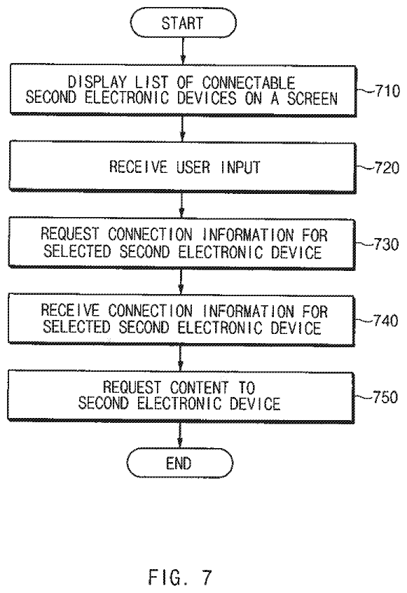

FIG. 7 is a flowchart illustrating a process of accessing an external device using connection information according to various embodiments.

Referring to FIG. 7, in operation 710, a first electronic device (e.g., the first electronic device 301) may display, on a screen, a list of connectable second electronic devices (e.g., the second devices 302, 305a, 305b, 305c, 306a, 306b, 306c, and 308). The list may include a device recognized in the first electronic device via an authentication device (e.g., the authentication device 303) or a device recognized via a network without a separate authentication device.

In operation 720, the first electronic device (e.g., the first electronic device 301) may receive a user input of selecting one of the output list. For example, the user input may be a touch input on a screen or a selection input via a separate controller.

In operation 730, the first electronic device (e.g., the first electronic device 301) may request, to the authentication device (e.g., the authentication device 303), connection information for a selected second electronic device.

In operation 740, when user authentication (e.g., fingerprint recognition, iris recognition, or the like) is completed in the authentication device (e.g., the authentication device 303), the first electronic device (e.g., the first electronic device 301) may receive the connection information for the selected second electronic device. In one embodiment, the authentication device (e.g., the authentication device 303) may allow the user to select whether to transmit the connection information via a pop-up window for identifying the transmission of the connection information.

In operation 750, the first electronic device (e.g., the first electronic device 301) may use the received connection information to transmit a signal of requesting the content to the second electronic device (e.g., the second electronic device 302, 305a, 305b, 305c, 306a, 306b, 306c, and 308).

For example, in a case of remote control, the first electronic device may transmit, to the second electronic device, a request signal containing connection information (e.g., user ID/password) required for remotely controlling the second electronic device. The second electronic device may determine a validity of the received connection information. When the received connection information is valid, the second electronic device may establish a protocol for the remote control with the first electronic device.

A method for connecting a device according to various embodiments is performed in the electronic device which may be connected to the external device via the network. The method for connecting the device may include recognizing peripheral devices via the wired or wireless communication, receiving connection information for the connection to the external device from at least one of the peripheral devices, remotely controlling the external device based on the received connection information or outputting content stored in the external device on the display.

According to various embodiments, the recognizing of the peripheral devices may include receiving a list of one or more connection information stored in the peripheral devices.

According to various embodiments, the recognizing of the peripheral devices may include outputting, on the display, a list of the peripheral devices, the external device recognized based on the connection information stored in the peripheral devices, and device recognized via a separate network.

According to various embodiments, the outputting of the content on the display may include selecting and outputting one of redundant devices in the list based on a preset condition.

According to various embodiments, the receiving of the connection information may include receiving the connection information when user authentication processes respectively performed in the peripheral devices are valid.

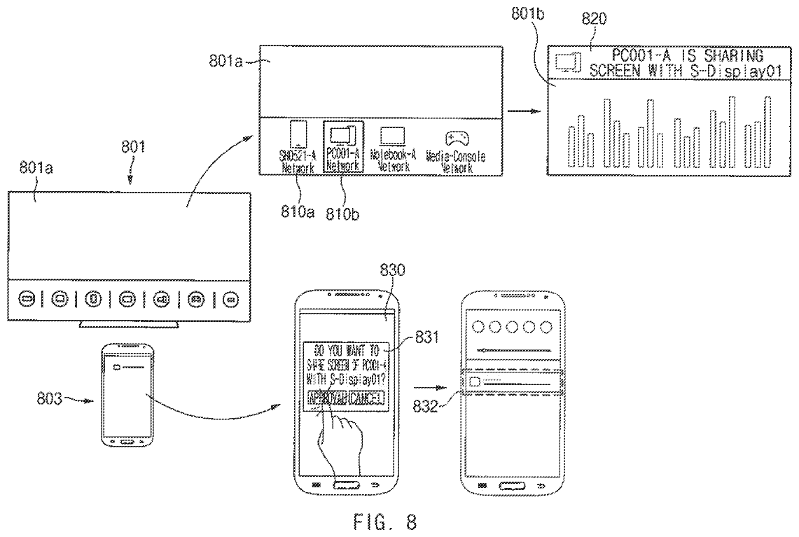

FIG. 8 is an exemplary diagram of remote control according to various embodiments.

Referring to FIG. 8, a first electronic device 801 may recognize peripheral electronic devices and display a list of connectable devices on a display 801a. For example, when the first electronic device 801 recognizes an authentication device 803, the display 801a may display an icon 810a for the authentication device 803 and an icon 810b for a second electronic device (not shown) recognizable via connection information stored in the authentication device 803. The authentication device 803 may provide the first electronic device 801 with information of a list of connection information stored in an internal memory.

In one embodiment, when the user selects the icon 810a corresponding to the authentication device 803 connected with the first electronic device 801 via the short-range communication, a screen of the authentication device 803 may be mirrored. In another embodiment, when the user selects the icon 810b for the second electronic device, remotely controlling, by the first electronic device 801, the second electronic device may be started.

The first electronic device 801 may use the authentication device 803 to obtain information for accessing the external second electronic device. The authentication device 803 may store in advance the connection information required for the connection to the second electronic device. For example, the connection information may include network information (e.g., IP address, MAC address, port information, and the like), and user account information (e.g., user ID/password).

When the user selects remote control of the second electronic device, the first electronic device 801 may request authentication information to the authentication device 803.

In one embodiment, the authentication device 803 may perform a separate user authentication process (e.g., fingerprint recognition, iris recognition, password input, or the like) in response of the request of the first electronic device 801 and then transmit the connection information when the user authentication is completed.

In another embodiment, when the user authentication is not required (e.g., when a screen unlock via the fingerprint occurs within a specified time), the authentication device 803 may output a user interface (e.g., a pop-up window 831) without requiring the separate user authentication to receive user's consent about providing of the connection information.

When the user authentication is completed or an approval input of the user occurs (e.g., selecting ‘approval’ in the pop-up window 831), the authentication device 803 may transmit the connection information to the first electronic device 801. When the connection information is transmitted, the authentication device 803 may display connection status information 832 between the first electronic device 801 and the second electronic device on the display. In one embodiment, when the user cancels the approval for use of the connection information in the authentication device 803, the remotely controlling, by the first electronic device 801, of the second electronic device may be terminated.

The first electronic device 801 may remotely control the second electronic device based on the received connection information for the second electronic device. In one embodiment, the first electronic device 801 may immediately start the remote control without the user authentication performed in the second electronic device. The first electronic device 801 may mirror and output a screen 801b being output on the second electronic device. User input (e.g., mouse input, keyboard input, or the like) occurring in the first electronic device 801 may be transmitted to the second electronic device and executed.

In one embodiment, the first electronic device 801 may output connection state information 820 between the first electronic device 801 and the second electronic device.

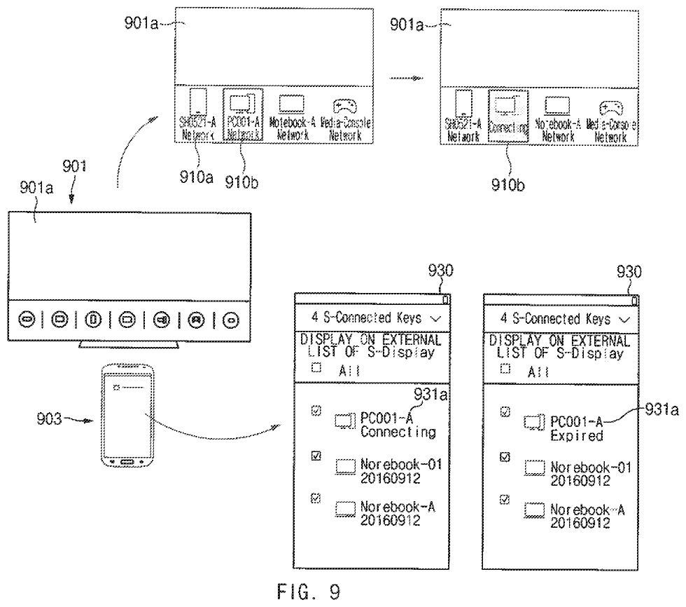

FIG. 9 is an exemplary diagram of connection failure screen according to various embodiments. FIG. 9 is illustrative, and the disclosure is not limited thereto.

Referring to FIG. 9, a first electronic device 901 may recognize peripheral electronic devices and display a list of connectable devices on a display 901a. For example, when the first electronic device 901 recognizes an authentication device 903, the display 901a may display an icon 910a for the authentication device 903 and an icon 910b for a second electronic device (not shown) recognizable via connection information stored in the authentication device 903. The authentication device 903 may provide the first electronic device 901 with information of a list of connection information stored in an internal memory.

According to various embodiments, the connection information stored in the authentication device 903 may become invalid due to a lapse of specified expiration date, setting changing by the user, or the like.

For example, when the user selects the icon 910b for the second electronic device, remotely controlling the second electronic device or accessing content stored in the second electronic device may be started.

The first electronic device 901 may transmit a request for remote control or content access to the second electronic device based on the connection information received from the authentication device 903.

The second electronic device may review the validity of the connection information in response to the request signal. For example, the second electronic device may review whether the expiration date of the connection information has lapsed, whether the request signal is within an authority range defined in the connection information, and the like.

When the connection information is not valid (e.g., the expiration date of the connection information is changed and is no longer valid, the password of the user account is changed, or the like), a connection rejection message may be transmitted in response to the request signal.

When the connection rejection message is received, the first electronic device 901 may notify the authentication device 903 that the connection information is invalid.

The authentication device 903 may indicate, in a list 930, that the expiration date of the connection information 931a for accessing the second electronic device is lapsed.

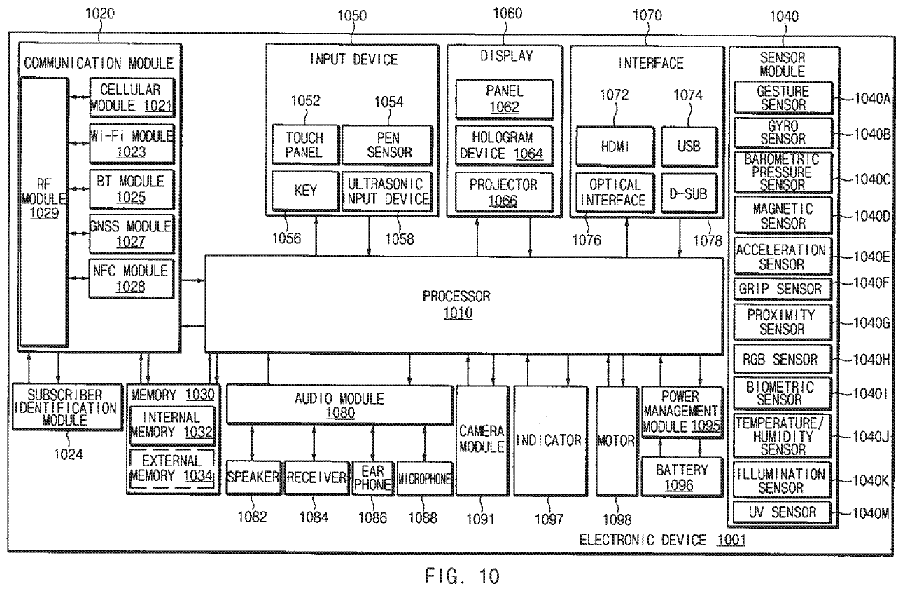

FIG. 10 is a block diagram illustrating an electronic device according to an embodiment of the present disclosure.

Referring to FIG. 10, an electronic device 1001 may include, for example, a part or the entirety of the electronic device 101 illustrated in FIG. 1. The electronic device 1001 may include at least one processor (e.g., AP) 1010, a communication module 1020, a subscriber identification module (SIM) 1024, a memory 1030, a sensor module 1040, an input device 1050, a display 1060, an interface 1070, an audio module 1080, a camera module 1091, a power management module 1095, a battery 1096, an indicator 1097, and a motor 1098. The processor 1010 may run an operating system or an application program so as to control a plurality of hardware or software elements connected to the processor 1010, and may process various data and perform operations. The processor 1010 may be implemented with, for example, a system on chip (SoC). According to an embodiment of the present disclosure, the processor 1010 may further include a graphic processing unit (GPU) and/or an image signal processor. The processor 1010 may include at least a portion (e.g., a cellular module 1021) of the elements illustrated in FIG. 10. The processor 1010 may load, on a volatile memory, an instruction or data received from at least one of other elements (e.g., a nonvolatile memory) to process the instruction or data, and may store various data in a nonvolatile memory.

The communication module 1020 may have a configuration that is the same as or similar to that of the communication interface 170 of FIG. 1. The communication module 1020 may include, for example, a cellular module 1021, a Wi-Fi module 1023, a Bluetooth (BT) module 1025, a GNSS module 1027 (e.g., a GPS module, a GLONASS module, a BeiDou module, or a Galileo module), a NFC module 1028, and a radio frequency (RF) module 1029. The cellular module 1021 may provide, for example, a voice call service, a video call service, a text message service, or an Internet service through a communication network. The cellular module 1021 may identify and authenticate the electronic device 1001 in the communication network using the subscriber identification module 1024 (e.g., a SIM card). The cellular module 1021 may perform at least a part of functions that may be provided by the processor 1010. The cellular module 1021 may include a communication processor (CP). Each of the Wi-Fi module 1023, the Bluetooth module 1025, the GNSS module 1027 and the NFC module 1028 may include, for example, a processor for processing data transmitted/received through the modules. According to some various embodiments of the present disclosure, at least a part (e.g., two or more) of the cellular module 1021, the Wi-Fi module 1023, the Bluetooth module 1025, the GNSS module 1027, and the NFC module 1028 may be included in a single integrated chip (IC) or IC package. The RF module 1029 may transmit/receive, for example, communication signals (e.g., RF signals). The RF module 1029 may include, for example, a transceiver, a power amp module (PAM), a frequency filter, a low noise amplifier (LNA), an antenna, or the like. According to another embodiment of the present disclosure, at least one of the cellular module 1021, the Wi-Fi module 1023, the Bluetooth module 1025, the GNSS module 1027, or the NFC module 1028 may transmit/receive RF signals through a separate RF module. The SIM 1024 may include, for example, an embedded SIM and/or a card containing the subscriber identity module, and may include unique identification information (e.g., an integrated circuit card identifier (ICCID)) or subscriber information (e.g., international mobile subscriber identity (IMSI)).

The memory 1030 (e.g., the memory 130) may include, for example, an internal memory 1032 or an external memory 1034. The internal memory 1032 may include at least one of a volatile memory (e.g., a dynamic RAM (DRAM), a static RAM (SRAM), a synchronous dynamic RAM (SDRAM), or the like), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like)), a hard drive, or a solid state drive (SSD). The external memory 1034 may include a flash drive such as a compact flash (CF), a secure digital (SD), a Micro-SD, a Mini-SD, an extreme digital (xD), a MultiMediaCard (MMC), a memory stick, or the like. The external memory 1034 may be operatively and/or physically connected to the electronic device 1001 through various interfaces.

The sensor module 1040 may, for example, measure physical quantity or detect an operation state of the electronic device 1001 so as to convert measured or detected information into an electrical signal. The sensor module 1040 may include, for example, at least one of a gesture sensor 1040A, a gyro sensor 1040B, a barometric pressure sensor 1040C, a magnetic sensor 1040D, an acceleration sensor 1040E, a grip sensor 1040F, a proximity sensor 1040G, a color sensor 1040H (e.g., a red/green/blue (RGB) sensor), a biometric sensor 1040I, a temperature/humidity sensor 1040J, an illumination sensor 1040K, or an ultraviolet (UV) sensor 1040M. Additionally or alternatively, the sensor module 1040 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 1040 may further include a control circuit for controlling at least one sensor included therein. In some various embodiments of the present disclosure, the electronic device 1001 may further include a processor configured to control the sensor module 1040 as a part of the processor 1010 or separately, so that the sensor module 1040 is controlled while the processor 1010 is in a sleep state.

The input device 1050 may include, for example, a touch panel 1052, a (digital) pen sensor 1054, a key 1056, or an ultrasonic input device 1058. The touch panel 1052 may employ at least one of capacitive, resistive, infrared, and ultraviolet sensing methods. The touch panel 1052 may further include a control circuit. The touch panel 1052 may further include a tactile layer so as to provide a haptic feedback to a user. The (digital) pen sensor 1054 may include, for example, a sheet for recognition which is a part of a touch panel or is separate. The key 1056 may include, for example, a physical button, an optical button, or a keypad. The ultrasonic input device 1058 may sense ultrasonic waves generated by an input tool through a microphone 1088 so as to identify data corresponding to the ultrasonic waves sensed.

The display 1060 (e.g., the display 160) may include a panel 1062, a hologram device 1064, or a projector 1066. The panel 1062 may have a configuration that is the same as or similar to that of the display 160 of FIG. 1. The panel 1062 may be, for example, flexible, transparent, or wearable. The panel 1062 and the touch panel 1052 may be integrated into a single module. The hologram device 1064 may display a stereoscopic image in a space using a light interference phenomenon. The projector 1066 may project light onto a screen so as to display an image. The screen may be disposed in the inside or the outside of the electronic device 1001. According to an embodiment of the present disclosure, the display 1060 may further include a control circuit for controlling the panel 1062, the hologram device 1064, or the projector 1066. The interface 1070 may include, for example, an HDMI 1072, a USB 1074, an optical interface 1076, or a D-subminiature (D-sub) 1078. The interface 1070, for example, may be included in the communication interface 170 illustrated in FIG. 1. Additionally or alternatively, the interface 1070 may include, for example, a mobile high-definition link (MHL) interface, an SD card/multi-media card (MMC) interface, or an infrared data association (IrDA) interface.

The audio module 1080 may convert, for example, a sound into an electrical signal or vice versa. At least a portion of elements of the audio module 1080 may be included in the input/output interface 150 illustrated in FIG. 1. The audio module 1080 may process sound information input or output through a speaker 1082, a receiver 1084, an earphone 1086, or the microphone 1088. The camera module 1091 is, for example, a device for shooting a still image or a video. According to an embodiment of the present disclosure, the camera module 1091 may include at least one image sensor (e.g., a front sensor or a rear sensor), a lens, an image signal processor (ISP), or a flash (e.g., an LED or a xenon lamp). The power management module 1095 may manage power of the electronic device 1001. According to an embodiment of the present disclosure, the power management module 1095 may include a power management integrated circuit (PMIC), a charger integrated circuit (IC), or a battery or gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 1096 and a voltage, current or temperature thereof while the battery is charged. The battery 1096 may include, for example, a rechargeable battery and/or a solar battery.

The indicator 1097 may display a specific state of the electronic device 1001 or a part thereof (e.g., the processor 1010), such as a booting state, a message state, a charging state, or the like. The motor 1098 may convert an electrical signal into a mechanical vibration, and may generate a vibration or haptic effect. Although not illustrated, a processing device (e.g., a GPU) for supporting a mobile TV may be included in the electronic device 1001. The processing device for supporting a mobile TV may process media data according to the standards of digital multimedia broadcasting (DMB), digital video broadcasting (DVB), MediaFLO™, or the like. Each of the elements described herein may be configured with one or more components, and the names of the elements may be changed according to the type of an electronic device. In various embodiments of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

According to various embodiments, an electronic device is connectable to an external device via a network and includes a display configured to output internal content of the electronic device or content received from the external device, a communication interface configured to support a wired or wireless communication, a memory and a processor, wherein the processor is configured to recognize peripheral devices via the wired or wireless communication, receive connection information for connection to the external device from at least one of the peripheral devices, remotely control the external device or output content stored in the external device on the display, based on the received connection information.

According to various embodiments, the processor is configured to receive a list of one or more connection information stored in the peripheral devices when the peripheral devices are recognized.

According to various embodiments, the processor is configured to output, on the display, a list of the peripheral devices, the external device recognized based on the connection information stored in the peripheral devices, and a device recognized via a separate network. The processor is configured to select and output one of redundant devices in the list based on a preset condition.

According to various embodiments, the connection information includes at least one of network information of the external device, user account information, device information of the external device, or security information. The network information includes at least one of an IP address, a MAC address, or a port number of the external device. The user account information includes user identification information and password information for remotely controlling the external device. The security information includes at least one of key identification information, key transmission date and time, and identification information of an authentication device received a key. The connection information further includes path information of the content stored in the external device. The processor is configured to execute a file stored in a region corresponding to the path information of an internal memory of the external device.

According to various embodiments, when a result of user authentication procedure performed in each of the peripheral devices is valid, the processor is configured to receive the connection information.

According to various embodiments, wherein when connection approval input from a user occurs in each of the peripheral devices, the processor is configured to receive the connection information. When a connection rejection message is received from the external device, the processor is configured to transmit the connection rejection message to the peripheral device.

According to various embodiments, the processor is configured to search for the peripheral devices via a short-range communication. The short-range communication includes at least one of Bluetooth, Bluetooth low power (BLE), wi-di, Zigbee, NFC (near field communication), magnetic secure transmission, radio frequency (RF), or body area network (BAN).

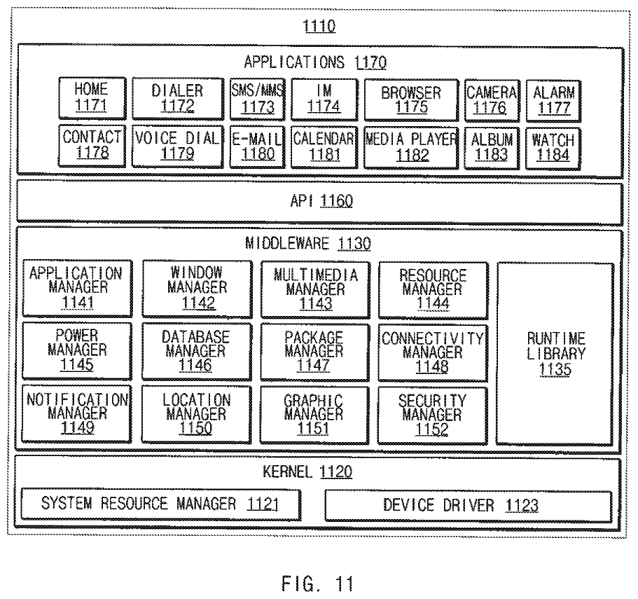

FIG. 11 is a block diagram illustrating a program module according to an embodiment of the present disclosure. According to an embodiment, the program module 1110 (e.g., the program 140) may include an operating system (OS) for controlling a resource related to an electronic device (e.g., the electronic device 101) and/or various applications (e.g., the application program 147) running on the OS. The operating system may be, for example, Android™, iOS™, Windows™, Symbian™, Tizen™, or Bada™. Referring to FIG. 11, the program module 1110 may include a kernel 1120, a middleware 1130, an API 1160, and/or an application 1170. At least a part of the program module 1110 may be preloaded on an electronic device or may be downloaded from an external electronic device (e.g., the first electronic device 102, the second external electronic device 104, or the server 106).

The kernel 1120 (e.g., the kernel 141) may include, for example, a system resource manager 1121 or a device driver 1123. The system resource manager 1121 may perform control, allocation, or retrieval of a system resource. According to an embodiment of the present disclosure, the system resource manager 1121 may include a process management unit, a memory management unit, a file system management unit, or the like. The device driver 1123 may include, for example, a display driver, a camera driver, a Bluetooth driver, a shared memory driver, a USB driver, a keypad driver, a Wi-Fi driver, an audio driver, or an inter-process communication (IPC) driver. The middleware 1130, for example, may provide a function that the applications 1170 require in common, or may provide various functions to the applications 1170 through the API 1160 so that the applications 1170 may efficiently use limited system resources in the electronic device. According to an embodiment of the present disclosure, the middleware 1130 (e.g., the middleware 143) may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, and a security manager 1152.

The runtime library 1135 may include, for example, a library module that a complier uses to add a new function through a programming language while the application 1170 is running. The runtime library 1135 may perform a function for input/output management, memory management, or an arithmetic function. The application manager 1141 may mange, for example, a life cycle of at least one of the applications 1170. The window manager 1142 may manage a GUI resource used in a screen. The multimedia manager 1143 may recognize a format required for playing various media files and may encode or decode a media file using a codec matched to the format. The resource manager 1144 may manage a resource such as a source code, a memory, or a storage space of at least one of the applications 1170. The power manager 1145, for example, may operate together with a basic input/output system (BIOS) to manage a battery or power and may provide power information required for operating the electronic device. The database manager 1146 may generate, search, or modify a database to be used in at least one of the applications 1170. The package manager 1147 may manage installation or update of an application distributed in a package file format.

The connectivity manger 1148 may manage wireless connection of Wi-Fi, Bluetooth, or the like. The notification manager 1149 may display or notify an event such as message arrival, appointments, and proximity alerts in such a manner as not to disturb a user. The location manager 1150 may manage location information of the electronic device. The graphic manager 1151 may manage a graphic effect to be provided to a user or a user interface related thereto. The security manager 1152 may provide various security functions required for system security or user authentication. According to an embodiment of the present disclosure, in the case in which an electronic device (e.g., the electronic device 101) includes a phone function, the middleware 1130 may further include a telephony manager for managing a voice or video call function of the electronic device. The middleware 1130 may include a middleware module for forming a combination of various functions of the above-mentioned elements. The middleware 1130 may provide a module specialized for each type of an operating system to provide differentiated functions. Furthermore, the middleware 1130 may delete a part of existing elements or may add new elements dynamically. The API 1160 (e.g., the API 145) which is, for example, a set of API programming functions may be provided in different configurations according to an operating system. For example, in the case of Android or iOS, one API set may be provided for each platform, and, in the case of Tizen, at least two API sets may be provided for each platform.

The application 1170 (e.g., the application program 147), for example, may include at least one application capable of performing functions such as a home 1171, a dialer 1172, an SMS/MMS 1173, an instant message (IM) 1174, a browser 1175, a camera 1176, an alarm 1177, a contact 1178, a voice dial 1179, an e-mail 1180, a calendar 1181, a media player 1182, an album 1183, a clock 1184, health care (e.g., measure an exercise amount or blood sugar), or environmental information provision (e.g., provide air pressure, humidity, or temperature information). According to an embodiment of the present disclosure, the application 1170 may include an information exchange application for supporting information exchange between the electronic device (e.g., the electronic device 101) and an external electronic device (e.g., the first electronic device 102 or the second external electronic device 104). The information exchange application may include, for example, a notification relay application for relaying specific information to the external electronic device or a device management application for managing the external electronic device. For example, the notification relay application may have a function for relaying, to an external electronic device (e.g., the first electronic device 102 or the second external electronic device 104), notification information generated in another application (e.g., an SMS/MMS application, an e-mail application, a health care application, an environmental information application, or the like) of the electronic device. Furthermore, the notification relay application may receive notification information from the external electronic device and may provide the received notification information to the user. The device management application, for example, may manage (e.g., install, delete, or update) at least one function (e.g., turn-on/turn off of the external electronic device itself (or some elements) or the brightness (or resolution) adjustment of a display) of the external electronic device (e.g., the first electronic device 102 or the second external electronic device 104) communicating with the electronic device, an application running in the external electronic device, or a service (e.g., a call service, a message service, or the like) provided from the external electronic device. According to an embodiment of the present disclosure, the application 1170 may include a specified application (e.g., a healthcare application of a mobile medical device) according to an attribute of the external electronic device (e.g., the first electronic device 102 or the second external electronic device 104). The application 1170 may include an application received from an external electronic device (e.g., the first electronic device 102 or the second external electronic device 104). The application 1170 may include a preloaded application or a third-party application downloadable from a server. The names of the elements of the program module 1110 illustrated may vary with the type of an operating system. According to various embodiments of the present disclosure, at least a part of the program module 1110 may be implemented with software, firmware, hardware, or a combination thereof. At least a part of the program module 1110, for example, may be implemented (e.g., executed) by a processor (e.g., the processor 1010). At least a part of the program module 1110 may include, for example, a module, a program, a routine, sets of instructions, or a process for performing at least one function.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed. At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 120), the processor may perform functions corresponding to the instructions. The computer-readable storage medium may be, for example, the memory 130. A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or an internal memory. The program instructions may include machine language codes generated by compilers and high-level language codes that can be executed by computers using interpreters. A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

1. An electronic device connectable to an external device via a network, the electronic device comprising:
a display configured to output internal content of the electronic device or content received from the external device;
a communication interface configured to support a wired or wireless communication;
a memory; and
a processor,
wherein the processor is configured to:
recognize peripheral devices via the wired or wireless communication;
receive connection information for connection to the external device from at least one of the peripheral devices;
remotely control the external device or output content stored in the external device on the display, based on the received connection information.

2. The electronic device of claim 1, wherein the processor is configured to receive a list of one or more connection information stored in the peripheral devices when the peripheral devices are recognized.

3. The electronic device of claim 1, wherein the processor is configured to output, on the display, a list of the peripheral devices, the external device recognized based on the connection information stored in the peripheral devices, and a device recognized via a separate network.

4. The electronic device of claim 3, wherein the processor is configured to select and output one of redundant devices in the list based on a preset condition.

5. The electronic device of claim 1, wherein the connection information includes at least one of network information of the external device, user account information, device information of the external device, or security information.

6. The electronic device of claim 5, wherein the network information includes at least one of an IP address, a MAC address, or a port number of the external device.

7. The electronic device of claim 5, wherein the user account information includes user identification information and password information for remotely controlling the external device.

8. The electronic device of claim 6, wherein the security information includes at least one of key identification information, key transmission date and time, and identification information of an authentication device received a key.

9. The electronic device of claim 5, wherein the connection information further includes path information of the content stored in the external device.

10. The electronic device of claim 9, wherein the processor is configured to execute a file stored in a region corresponding to the path information of an internal memory of the external device.

11. The electronic device of claim 1, wherein when a result of user authentication procedure performed in each of the peripheral devices is valid, the processor is configured to receive the connection information.

12. The electronic device of claim 1, wherein when connection approval input from a user occurs in each of the peripheral devices, the processor is configured to receive the connection information.

13. The electronic device of claim 1, wherein when a connection rejection message is received from the external device, the processor is configured to transmit the connection rejection message to the peripheral device.

14. The electronic device of claim 1, wherein the processor is configured to search for the peripheral devices via a short-range communication.

15. A device connecting method which is performed by an electronic device connectable to an external device, the method comprising:
recognizing peripheral devices via a wired or wireless communication;
receiving connection information for connection to the external device from at least one of the peripheral devices; and
remotely controlling the external device or outputting content stored in the external device on a display, based on the received connection information.
